(19) United States
(12) Patent Application Publication
(10) Pub. No.: US 2022/0066983 A1
(43) Pub. Date: Mar. 3, 2022

(54) SYSTEM AND METHOD FOR THE AUTOMATED SCHEDULING AND RETRIEVAL OF ARCHIVED DATA

(71) Applicant: PASCHKE CONSULTING, INC., Pensacola, FL (US)

(72) Inventor: James PASCHKE, Pensacola, FL (US)

(21) Appl. No.: 17/462,134

(22) Filed: Aug. 31, 2021

Related U.S. Application Data
(60) Provisional application No. 63/072,403, filed on Aug. 31, 2020.

(51) Int. Cl. G06F 16/11; G06F 16/22; G06F 16/25

(52) U.S. Cl. CPC G06F 16/113; G06F 16/258; G06F 16/2282

(57) ABSTRACT

A system and method for scheduling archival of enterprise relevant data and retrieving archived data on enterprise and organizational data archives. The archive scheduling system includes a computerized method of creating all ERP system variants identically except for date selections to insure mutually exclusive data ranges and enables the automated simultaneous processing and completion of archival tasks using parallel computing. The archive access and data retrieval system includes pre-request processing and customization to validate each request, validate each request's corresponding Infostructure, perform advance hashing to more closely determine relevant tables for the request, and to determine which method of file reading will most efficiently return results. The access and retrieval method is phased to fulfill a mediated request for access and/or retrieval in a resource and time efficient manner alone or in combination of phases.

### CROSS-REFERENCE TO RELATED APPLICATIONS

To the full extent permitted by law, the present U.S. patent application hereby claims priority to and the full benefit of, U.S. Provisional Application No. 63/072,403, filed Aug. 31, 2020, entitled “System and Method for the Automated Scheduling and Retrieval of Archived Data”, which is incorporated herein by reference in its entirety.

### FIELD OF THE DISCLOSURE

The present disclosure is directed to database and file management or data structures. More specifically, the disclosure is directed to migration and/or archival of business-relevant data into a computer-based system for later access and retrieval.

The present disclosure is not limited to any specific file management system, database structure, physical computing infrastructure, enterprise resource planning (ERP) system/software, or computer code language.

### BACKGROUND

Large organizations, such as firms, businesses, governments, hospital (networks), and educational institutions, often use software applications to perform operations, execute transactions, and record numerous other events which occur during the ordinary conduct of their business. Such software is often referred to as “enterprise software”. In general, these software packages have evolved over the years to include numerous enterprise resources to assist with forecasting, reporting, and database management. These comprehensive platforms upon which enterprises may comprehensively execute, plan, and investigate issues within the enterprise are known as “Enterprise Resource Planning” systems or software, or simply “ERP”. Using these enterprise resource planning systems, entities within an organization can accomplish enterprise-related tasks, the resulting actions of which may be recorded onto non-transitory computer readable media for later access and processing or reference. At organizational volume, the resulting data which accumulates over time might be processed in large quantities to generate custom, standard, or automated reports, business forecasting, or to otherwise make organization-relevant observations and test hypotheses. These data are often stored locally, with offsite automated backup, or may be stored distributivity on the “Cloud”. For example, a small organization may operate a single enterprise software computer workstation which saves all data to a storage media within or directly connected to the computer workstation. Larger organizations may implement more complicated storage systems, which in turn become more complicated as more agents of the organization access, retrieve, modify, and/or otherwise “touch” an organizational file system. Data on these systems may be stored in one format or multiple, including, for example, native files, Structured Query Language (SQL) databases, spreadsheets, comma-separated value (CSV) files, and other business intelligence artifacts.

These ERP systems and their corresponding file systems usually include well-known formatting structures so as to communicate information about any particular file within the system without requiring the entire file be opened. Usually, though not always, data is formatted into rows and columns (or their analogs), like in a spreadsheet. Columns in such a file system usually indicate relevant information about the file, such as date created or author. Then, when searching, for example, for a file created by a specific author on a specific date, software reading the file system need not read all given files to determine whether a field or term within the file contains the author's name and the specific date, but rather it can “scan” the columns for the author, check if the date matches the date specified, and assemble a list of results for all files created by that author on that date. Conversely, the software reading the file system could first determine if a file was created on the specific date, then check to determine whether the author created the file, and achieve the same results. The data appearing in the columns of such a file system is usually aligns with the definition of metadata, or data about data. Rows in such systems usually point to individual files or records within the system, can usually be sorted in specific orders based on data within the rows ‘columns’, and thereby individual records may be easily found by simple ascending or descending scan(s) through the organized table.

As organizations grow, complexity of the organization and the way they record data relevant to the organization usually grows with the organization. As technology continues to become more affordable for organizations and individuals alike, organizations and those in their employ have adopted an increasing number of computing devices by which they conduct the business of the organization. Correspondingly, the network of devices connected to any central organizational data repository grows in volume and complexity. At some point, most organizations may decide to archive a subset of all its stored enterprise-relevant data based upon an archiving policy to limit resources required for active databases. Such a decision enables older data to be stored on more economical equipment, in a more economical location, or on a more economical storage medium. This way, the organization may reserve its high-performance equipment for data which is more routinely accessed. The data archive may generally comprise the organization's more important data and any non-important may be stored separately, so as to retain the data, or the non-important data may be simply deleted. It may be stored on a computing device, which may commonly be a single-purpose server or virtual server having an archival data store capability. This process of archiving may occur manually or automatically on a schedule. For instance, an organization's accounting department may retain five fiscal years' data on a live database, five additional years' data in its archive, and permanently store its older data on computer readable media which may or may not be accessible via a network, or even may delete data beyond a certain anniversary.

The primary drawbacks with archiving organizational data have always been speed by which the archive is generated, the labor cost of administrating an archive, and the speed by which the database may be queried. Often archiving means a time consuming, well-planned, and labor-intensive process. While the archiving then frees resources for a live database, archives requiring constant updating and routine access are often a point of frustration within an organization, which in turn causes additional labor costs.

Several known methods exist to minimize the labor and time required for scheduling, migrating, and retrieving archived data. First, it should be observed that not all metadata for all files need be formulated into a column in a spreadsheet or database. Additionally, some fields may be inferred from others. For instance, a butcher shop may create a file for each sale that includes the customer's name, the type of meats purchased, each corresponding weight, each corresponding market price, the price paid for each meat, and the total. A file system saving only the type, weight, and market price could infer the price paid for each meat and the total using basic mathematics. So long as the “total” field is not of particular interest, eliminating this column could slightly decrease labor and time required to schedule, migrate, and then access the data in archive. Doing so across many fields which may be inferred could result in further efficiency increases when performing these tasks. However, it could also have the opposite effect should the total field be of interest during querying and retrieval. Other measures to improve the efficiency of these tasks include but are not limited to further archival of static and infrequently accessed data to minimize data on the archive, data compression, simply deleting old and static data on a schedule or based on automated policies, separate storage of metadata with reference/address/instruction to where source files are located, or through other manual or automatic processes which seek to organize and reduce the size of the archived data.

However, querying archived databases in organizations, as well as the setup and provision of such databases, can still be unwieldy. For instance, during retrieval a poorly planned query which does not contain a Key Value or key figure may result in a system performing a full table scan, which can take prolonged periods of time and even time out on some ERP systems. Other performance issues could result from the fact that some data may be better retrieved through sequential access where other data may be better retrieved using direct access. Software used to query archived data may either default to or select sequential or direct based upon the query type and/or the type of expected query result. However, it may be true that a query may benefit from both sequential and direct access, and such a query usually must be made twice, changing the access type for each query, rather than be performed simultaneously or switching on-the-fly. Finally, certain other queries may require the reading of a large number of archived files serially, (i.e., one at a time) which poses even greater performance concerns. With regard to setting up and provisioning an archived file database, policies, automation, and optimization each require thought and high-cost labor to ensure faithful execution and completion of the archival process, as well as performance, stability, and security to avoid mistakes that could cause lost data, inconsistent performance, or security issues.

Still other issues may relate to features related specifically to ERP archive systems or to the specific ERP archive systems themselves. For instance, archives created using a SAP archiving system may create Archive Sessions using at least 1 but not more than 999 Archive Files. Since ADMI VARIA, the standard SAP Table which is used to store Contents of the Variant for the Archiving Program data, operates at the Archive Session level, indexing on a standard (non-custom) SAP deployment usually does not occur at the Archive File level. This lack of an Archive File level index may cause an access and/or retrieval request to scan, in order to rule out, irrelevant Archive Files, rather than allowing for the disassembly of an individual request for access/retrieval into optimized sub-requests based upon the context within the request. This may be especially true of the specific SAP system data archive, and the underlying request for access and/or retrieval of data, requires potential access to thousands of records spread across hundreds of Archive Files spread across yet other potentially dozens of Archive Sessions. Due to these underlying complexities and limitations of SAP systems, and the archival thereof, example choke-points in any given request for access and/or retrieval may include at least: (i) reading the SAP infostructure (ZARIX table) with non-Key Values triggering a full-table scan, (ii) reading the SAP Archive (ADK) files with the wrong access type (sequential vs. direct), and/or (iii) reading a large number of SAP ADK files synchronously (serially). Each of these issues may cause excessive wait times for access and/or retrieval of data or may cause significant system resources during execution. By addressing these issues, efficiencies may be gained in both system resource consumption and wait time.

Therefore, a need exists for a system and method of scheduling archival tasks and querying/retrieving the subsequently archived data which minimizes the time and expense of performing queries upon the archived data. The instant disclosure may be designed to address at least certain aspects of the problems or needs discussed above by providing such a system and method for the automated scheduling and retrieval of archived data.

### SUMMARY

The present disclosure may solve the aforementioned limitations of the currently available systems and methods of scheduling and retrieving archived data from a database using enterprise archival software, by providing a novel method of archive scheduling and archive retrieval. With respect to scheduling the archival of data, the system and method of the disclosure may relate to variants, and creating them identically in a systematic approach. The system and method of automatically scheduling data archival may also relate to automating the running of the archival process in parallel, using parallel processing servers. With regard to querying and retrieving data from the resulting archived data, a combination of improvements to the operational order, pre-query transmission processing, post-query transmission processing, and hashing scheme may markedly improve query performance. Furthermore, on-the-fly access type switching may further improve this performance.

In a potentially preferred exemplary embodiment, several improvements to the creation and querying process may be required to fully benefit from the system and method of the disclosure. Briefly, these may include dynamic access method switching, dynamic submission mode switching, an improved hashing scheme, and a dynamic field assignment with data selection. Alone or in combination, each of these improvements may contribute to improved archival performance, which will be better understood by those skilled in the art after a full review of this Summary along with the Drawings and Detailed Description below.

In one exemplary embodiment that includes dynamic access method switching, efficiencies may be gained or ensured during access and retrieval of data stored on an archive. Dynamic access method switching may be accomplished using automated software, methods, or procedures which allow both sequential and direct access of an archive without requiring multiple requests by a user or machine requesting access and retrieval from the archive. Dynamic access method switching will be understood in greater detail by those having skill in the art after a more thorough review of the Drawings and Detailed Description.

In another exemplary embodiment, dynamic submission mode switching may be implemented to enable user and machine requests to an archived database to switch, either manually or automatically, between serial and parallel submission of individual requests and queries depending on whether dialog processes are available in real time ensure the most efficient execution of archive data request among sub-requests.

In yet another exemplary embodiment, a unique hashing scheme may enable the systems and methods of the disclosure to restrict data accesses to as few Archive Files as possible prior to second-level indexing and method and mode determinations. In connection with or separate from this embodiment may include dynamic field assignment and data selection systems and method which may ensure high-speed and extremely flexible indexing options. Dynamic field assignment and data selection may occur on both a first and second level hashing scheme. A first hashing scheme (i.e., the hashing scheme assigned to a first or Level 1 indexing) may have archival enterprise software standard hashing with the addition of customized hashing schemes to allow for this limited, Level 1 access, prior to Level 2 indexing. At the second or Level 2 indexing, optional infostructures may be utilized as indexes into each individual data or Archive Object within each Archive File. This may occur across a portion or all of said Archive Objects within each of said Archive File. In combination with other features of the disclosed system and method, by implementing this unique hashing scheme alongside standard hashing schemes, dynamic field assignment and data selection may enable accessing archive data using complete infostructures, partial infostructures, or absent infostructures, depending on the unique features of any given archival query.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1A is a block diagram of a computer system of the present disclosure;

FIG. 1B is a block diagram of a communications system implemented by the computer system in FIG. 1A;

FIG. 2 is a flowchart diagram of the automatic archive scheduler system and method of the present disclosure;

FIG. 3 is a summary flowchart diagram of an exemplary phased system of the present disclosure;

FIG. 4 is a detailed flowchart diagram of an exemplary read request validation phase of the present disclosure;

FIG. 5 is a detailed flowchart diagram of an exemplary hashing phase of the present disclosure;

FIG. 6 is a detailed flowchart diagram of an exemplary Level 2 individual key and offset phase of the present disclosure;

FIG. 7 is a detailed flowchart diagram of an exemplary access method phase of the present disclosure;

FIG. 8 is a detailed flowchart diagram of an exemplary results phase of the present disclosure;

FIG. 9A is a screenshot drawing of an exemplary user interface for accessing archival data; and

FIG. 9B is a screenshot drawing of an exemplary user interface for accessing archival data.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

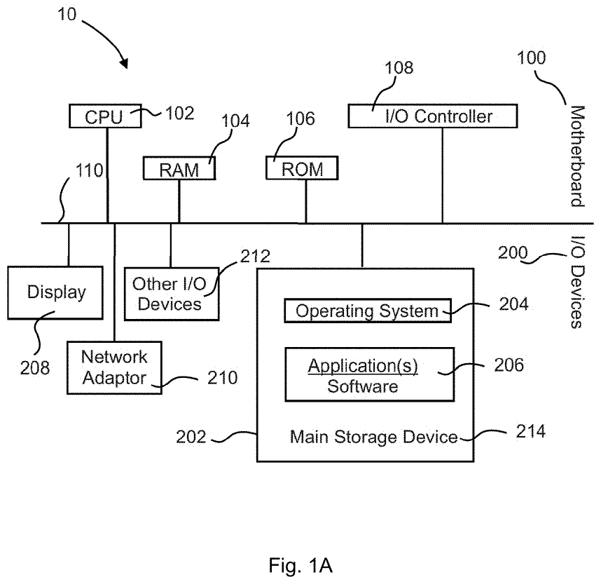

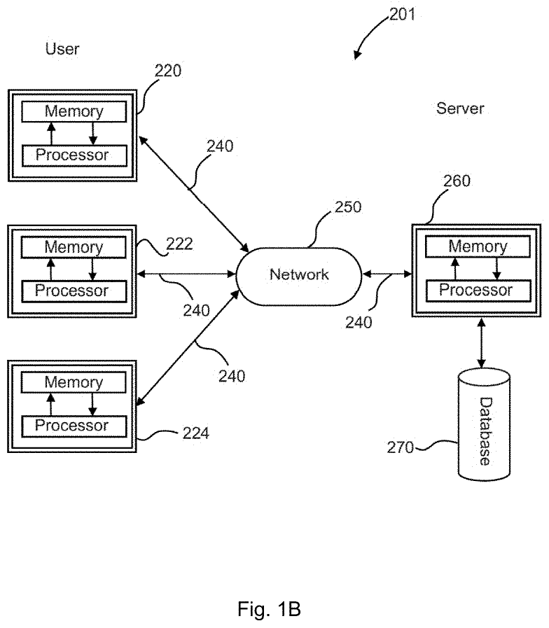

Referring now to FIGS. 1A-9B, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

The present disclosure solves the aforementioned limitations of the currently available devices and methods of storage, archiving, accessing, and organization by providing a system and method for the automated scheduling and retrieval of archived data.

In describing the exemplary embodiments of the present disclosure, as illustrated in FIGS. 1A-1B. specific terminology is employed for the sake of clarity. The present disclosure, however, is not intended to be limited to the specific terminology so selected, and it is to be understood that each specific element includes all technical equivalents that operate in a similar manner to accomplish similar functions. The claimed invention may, however, be embodied in many different forms and should not be construed to be limited to the embodiments set forth herein. The examples set forth herein are non-limiting examples, and are merely examples among other possible examples.

As will be appreciated by one of skill in the art, the present disclosure may be embodied as a method, data processing system, or computer program product. Accordingly, the present disclosure may take the form of an entirely hardware embodiment, entirely software embodiment or an embodiment combining software and hardware aspects. Furthermore, the present disclosure may take the form of a computer program product on a computer-readable storage medium having computer-readable program code means embodied in the medium. Any suitable computer readable medium may be utilized, including hard disks, ROM, RAM, CD-ROMs, electrical, optical, magnetic storage devices and the like.

The present disclosure is described below with reference to flowchart illustrations of methods, apparatus (systems) and computer program products according to embodiments of the present disclosure. It will be understood that each block or step of the flowchart illustrations, and combinations of blocks or steps in the flowchart illustrations, can be implemented by computer program instructions or operations. These computer program instructions or operations may be loaded onto a general-purpose computer, special purpose computer, or other programmable data processing apparatus to produce a machine, such that the instructions or operations, which execute on the computer or other programmable data processing apparatus, create means for implementing the functions specified in the flowchart block or blocks/step or steps.

These computer program instructions or operations may also be stored in a computer-usable memory that can direct a computer or other programmable data processing apparatus to function in a particular manner, such that the instructions or operations stored in the computer-usable memory produce an article of manufacture including instruction means which implement the function specified in the flowchart block or blocks/step or steps. The computer program instructions or operations may also be loaded onto a computer or other programmable data processing apparatus (processor) to cause a series of operational steps to be performed on the computer or other programmable apparatus (processor) to produce a computer implemented process such that the instructions or operations which execute on the computer or other programmable apparatus (processor) provide steps for implementing the functions specified in the flowchart block or blocks/step or steps.

Accordingly, blocks or steps of the flowchart illustrations support combinations of means for performing the specified functions, combinations of steps for performing the specified functions, and program instruction means for performing the specified functions. It should also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions or operations.

Computer programming for implementing the present disclosure may be written in various programming languages, database languages, and the like. However, it is understood that other source or object-oriented programming languages, and other conventional programming language may be utilized without departing from the spirit and intent of the present disclosure.

Referring now to FIG. 1A, there is illustrated a block diagram of a computing system 10 that provides a suitable environment for implementing embodiments of the present disclosure. The computer architecture shown in FIG. 1A is divided into two parts—motherboard 100 and the input/output (I/O) devices 200. Motherboard 100 preferably includes subsystems and/or processor(s) to execute instructions such as central processing unit (CPU) 102, a memory device, such as random access memory (RAM) 104, input/output (I/O) controller 108, and a memory device such as read-only memory (ROM) 106, also known as firmware, which are interconnected by bus 110. A basic input output system (BIOS) containing the basic routines that help to transfer information between elements within the subsystems of the computer is preferably stored in ROM 106, or operably disposed in RAM 104. Computing system 10 further preferably includes I/O devices 202, such as main storage device 214 for storing operating system 294 and instructions or application program(s) 206, and display 208 for visual output, and other I/O devices 212 as appropriate. Main storage device 214 preferably is connected to CPU 102 through a main storage controller (represented as 108) connected to bus 110. Network adapter 210 allows the computer system to send and receive data through communication devices or any other network adapter capable of transmitting and receiving data over a communications link that is either a wired, optical, or wireless data pathway. It is recognized herein that central processing unit (CPU) 102 performs instructions, operations or commands stored in ROM 106 or RAM 104.

Processor 102 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1A as a single processor, in some embodiments, processor 102 comprises a plurality of processors. The plurality of processors may be embodied on a single computing device or may be distributed across a plurality of computing devices collectively configured to function as the computing device 10. The plurality of processors may be in operative communication with each other and may be collectively configured to perform one or more functionalities of the computing device 10 as described herein. In an example embodiment, processor 102 is configured to execute instructions stored in memory 104, 106 or otherwise accessible to processor 102. These instructions, when executed by processor 102, may cause the computing device 10 to perform one or more of the functionalities of the computing device 10 as described herein.

Whether configured by hardware, firmware/software methods, or by a combination thereof, processor 102 may comprise an entity capable of performing operations according to embodiments of the present invention while configured accordingly. Thus, for example, when processor 102 is embodied as an ASIC, FPGA or the like, processor 102 may comprise specifically configured hardware for conducting one or more operations described herein. As another example, when processor 102 is embodied as an executor of instructions, such as may be stored in memory 104, 106, the instructions may specifically configure processor 102 to perform one or more algorithms and operations described herein.

The plurality of memory components 104, 106 may be embodied on a single computing device 10 or distributed across a plurality of computing devices. In various embodiments, memory may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 104, 106 may be configured to store information, data, applications, instructions, or the like for enabling the computing device 10 to carry out various functions in accordance with example embodiments discussed herein. For example, in at least some embodiments, memory 104, 106 is configured to buffer input data for processing by processor 102. Additionally or alternatively, in at least some embodiments, memory 104, 106 may be configured to store program instructions for execution by processor 102. Memory 104, 106 may store information in the form of static and/or dynamic information. This stored information may be stored and/or used by the computing device 10 during the course of performing its functionalities.

Many other devices or subsystems or other I/O devices 212 may be connected in a similar manner, including but not limited to, devices such as microphone, speakers, flash drive, CD-ROM player, DVD player, printer, main storage device 214, such as hard drive, and/or modem each connected via an I/O adapter. Also, although preferred, it is not necessary for all of the devices shown in FIG. 1A to be present to practice the present disclosure, as discussed below. Furthermore, the devices and subsystems may be interconnected in different configurations from that shown in FIG. 1A, or may be based on optical or gate arrays, or some combination of these elements that is capable of responding to and executing instructions or operations. The operation of a computer system such as that shown in FIG. 1A is readily known in the art and is not discussed in further detail in this application, so as not to overcomplicate the present discussion.

In some embodiments, some or all of the functionality or steps may be performed by processor 102. In this regard, the example processes and algorithms discussed herein can be performed by at least one processor 102. For example, non-transitory computer readable storage media can be configured to store firmware, one or more application programs, and/or other software, which include instructions and other computer-readable program code portions that can be executed to control processors of the components of system 201 to implement various operations, including the examples shown above. As such, a series of computer-readable program code portions may be embodied in one or more computer program products and can be used, with a computing device, server, and/or other programmable apparatus, to produce the machine-implemented processes discussed herein.

Any such computer program instructions and/or other type of code may be loaded onto a computer, processor or other programmable apparatuses circuitry to produce a machine, such that the computer, processor or other programmable circuitry that executes the code may be the means for implementing various functions, including those described herein.

Referring now to FIG. 1B, there is illustrated a diagram depicting an exemplary system 201 in which concepts consistent with the present disclosure may be implemented or performed. Examples of each element within the communication system 201 of FIG. 1B are broadly described above with respect to FIG. 1A. In particular, the server system 260 and user system 220 have attributes similar to computer system 10 of FIG. 1A and illustrate one possible implementation of computer system 10. Communication system 201 preferably includes one or more user systems 220, 222, 224, one or more server system 260, and network 250, which could be, for example, the Internet, public network, private network or cloud. User systems 220-224 each preferably include a computer-readable medium, such as random access memory, coupled to a processor. The processor, CPU 102, executes program instructions or operations stored in memory. Communication system 201 typically includes one or more user system 220. For example, user system 220 may include one or more general-purpose computers (e.g., personal computers), one or more special purpose computers (e.g., devices specifically programmed to communicate with each other and/or the server system 260), a workstation, a server, a device, a digital assistant or a “smart” cellular telephone or pager, a digital camera, a component, other equipment, or some combination of these elements that is capable of responding to and executing instructions or operations.

Similar to user system 220, server system 260 preferably includes a computer-readable medium, such as random access memory, coupled to a processor. The processor executes program instructions stored in memory. Server system 260 may also include a number of additional external or internal devices, such as, without limitation, a mouse, a CD-ROM, a keyboard, a display, a storage device and other attributes similar to computer system 10 of FIG. 1A. Server system 260 may additionally include a secondary storage element, such as database 270 for storage of data and information. Server system 260, although depicted as a single computer system, may be implemented as a network of computer processors. Memory in server system 260 contains one or more executable steps, program(s), algorithm(s), or application(s) 206 (shown in FIG. 1). For example, the server system 260 may include a web server, information server, application server, one or more general-purpose computers (e.g., personal computers), one or more special purpose computers (e.g., devices specifically programmed to communicate with each other), a workstation or other equipment, or some combination of these elements that is capable of responding to and executing instructions or operations.

System 201 is capable of delivering and exchanging data between user system 220 and a server system 260 through communications link 240 and/or network 250. Through user system 220, users can preferably communicate over network 250 with each other user system 220, 222, 224, and with other systems and devices, such as server system 260, to electronically transmit, store, manipulate, and/or otherwise use data exchanged between the user system and the server system. Communications link 240 typically includes network 250 making a direct or indirect communication between the user system 220 and the server system 260, irrespective of physical separation. Examples of a network 250 include the Internet, cloud, analog or digital wired and wireless networks, radio, television, cable, satellite, and/or any other delivery mechanism for carrying and/or transmitting data or other information, such as to electronically transmit, store, manipulate, and/or otherwise modify data exchanged between the user system and the server system. The communications link 240 may include, for example, a wired, wireless, cable, optical or satellite communication system or another pathway. It is contemplated herein that RAM 104, main storage device 214, and database 270 may be referred to herein as storage device(s) or memory device(s).

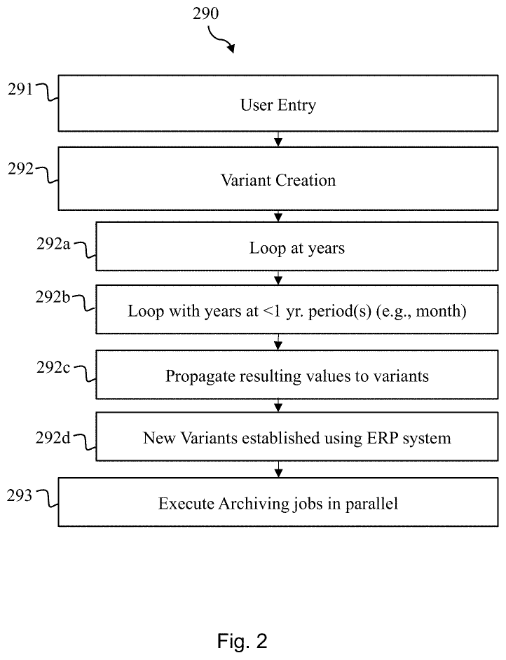

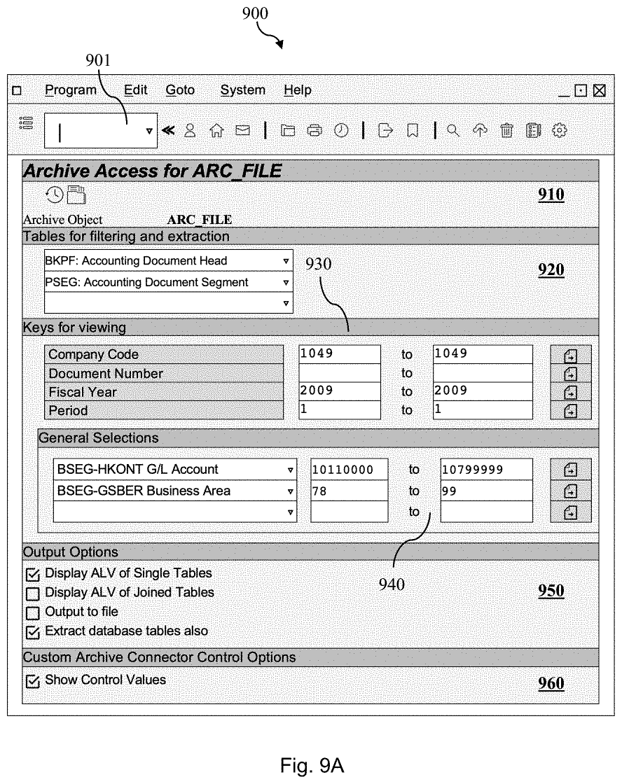

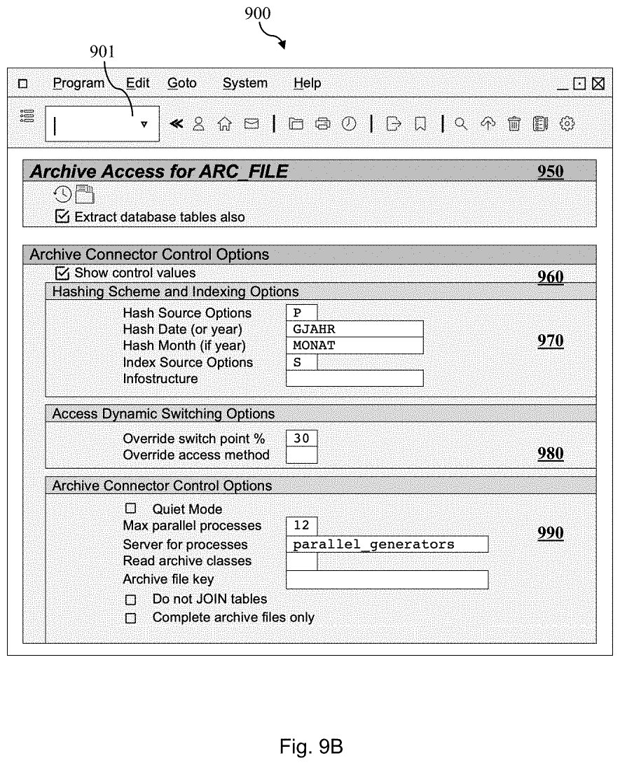

Referring now specifically to FIG. 2, therein illustrated is a flowchart of an exemplary automated scheduler system 290 of the present disclosure, as it may be implemented on one or more of a device 10 within system 201. When executing a mass number of archiving jobs in an ERP system having data archiving functionality, two tasks may require automation and control in order to ensure systematic archiving and organization. Leveraging this process to create data-relevant infostructures for any particular enterprise or enterprise business unit may increase efficiencies of both system utilization and response times. To begin this process, a user of exemplary automated archiver scheduler system 290 may make an entry at step 291 corresponding to a proposed data archive. This user entry at step 291 may include a range of years for archiving or the scheduling of archiving. Then, a series of variant creation steps 292 can proceed. Starting at step 292a and proceeding to step 292b, exemplary automated archive scheduler system 290 may loop to create year-, period-, and/or month-specific variants, each having mutually-exclusive subsets of data. These mutually-exclusive subsets of data may then later assist in supporting the parallelization of processing archival jobs at step 293. Once variants are properly propagated to ensure mutual-exclusivity of data corresponding to the variants during step 292c, they may be added as new one or more new variants to the established variant list utilized by the ERP system at step 292d. Finally, at step 293 the process of submitting archiving jobs can systematically proceed in parallel, using the new variant database structure. The process of mass creating variants requires may require one skilled in the art to understand how an ERP system's archiving system utilizes an Archive Object (AO) to handle each unique selection parameter and how the archiving system may format an AO. Often times, ERP systems and their archival processes use logic which is coded into the program to specifically instruct the system of how each AO selects based on dates. These systems also allow a user to select non-date selection criteria via a user interface, which then simply propagates to each variant created for the specific AO being created or processed. By enabling the user to supply date values by fiscal year and period, a date range in two parameter fields on a selection screen, two dates in “high” and “low” value field, the like and/or combinations thereof, the system of the disclosure can be enabled to use the date range requested to drive the variant creation date logic section of the disclosed method. From a user's perspective, the user would simply enter a range of years (or time period) for which they want to create variants (see FIGS. 9A-9B for exemplary user interfaces for selection screens). This entire period becomes the basis by which the system of the disclosure in generating an Archive Object containing Archive Files must loop and then create period- or month-specific variants within that entire period and do so in a manner (i.e., such that sufficient number of period-specific variants are created) that guarantee data within any single Archive File will always address mutually-exclusive data subsets, thus enabling support of batch job parallelization. Put more simply, looping may occur at the years, within that loop at the months or periods, which then propagate all the values to the variants and create the variants by executing a standard Function Module (FM) within the ERP system (e.g., SAP) for adding a variant to a program. When generated, each group of variants may have a common “prefix” (e.g., FI 0001), which can be user selected or assigned. By then looping at those variants and executing a series of standard FM's that are programmed to cause a device 10 to open, submit, and close a batch archiving job, the process of archive generation may be automated or staged for processing. During execution of each archival job process, a scheduler job or process may simultaneously monitor the job name and number for each job submitted in this scheduler. The scheduler may then query a table of completed jobs (e.g., ADMI JOBS in SAP) to determine when each submitted job completes. Once one completes, an “available” job slot may be opened up by the ERP system, and the scheduler may be programmed to submit the next job in order to keep the queue full.

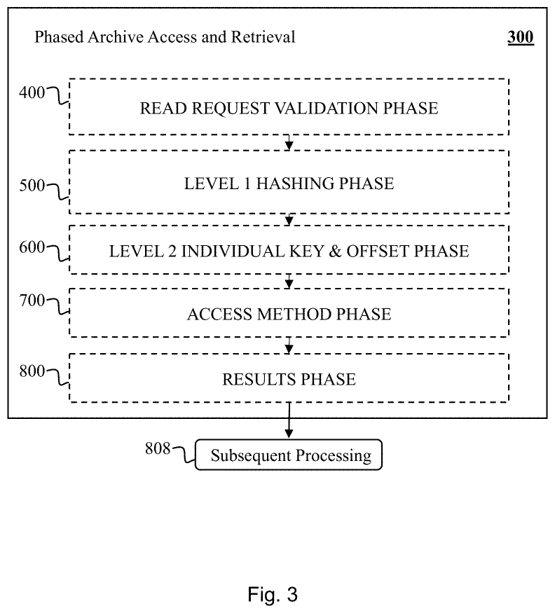

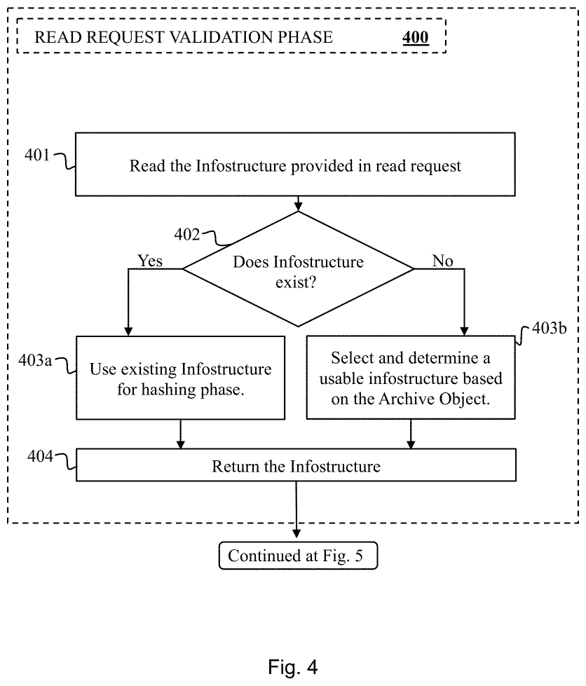

Referring now specifically to FIG. 3, therein illustrated is a summary flowchart diagram of an exemplary phased archive access and retrieval method 300 of the present disclosure, as it may be implemented across various devices 10 within system 201. Each step, sub-step, and/or phase within exemplary phased archive access and retrieval method 300 may be accomplished in the order and steps outlined herein, or may be adapted to include, exclude, and/or rearrange steps, sub-steps, and/or phases within exemplary phased archive access and retrieval method 300 so as to accomplish results which would be expected by those skilled in the art. At read request validation phase 400, a read request from a user is processed and a determination is made as to the corresponding configuration of the Archive Object and Archive Index (Infostructure). At Level 1 Hashing phase 500, a hashing scheme is performed upon Level 1 archive indexes to determine which Archive Files are in scope of a user request. At Level 2 individual key and offset phase 600, Level 2 archive indexes are read according to results provided at phase 500 to obtain individual Archive File Keys and Offset values. At access method phase 700, record counts may be analyzed to determine whether to access according to a user request via direct or sequential method. At results phase 800, the relevant records may be obtained and returned for subsequent processing 808. These phases 400-800, including their various steps and sub-steps and their corresponding advantages, will become more apparent to one skilled in the art from the following Detailed Description of exemplary embodiments thereof phases 400-800 when read in light of the accompanying FIGS. 4-8.

Referring now specifically to FIG. 4, therein illustrated is a detailed flowchart diagram of an exemplary read request validation phase 400 of the present disclosure, as it may be implemented across various devices 10 within system 201. At step 401, a request to read and/or request data from an archive may be initiated from a device 10 within system 201 to another device 10 having stored thereon a non-transitory computer readable medium (e.g., main storage device 214) an archival database. Alternatively, and in a potentially preferred embodiment of step 401, device 10 may initiate a request to access an Archive File via network 250 to server system 260 having database 270, the database having stored thereon an at least one archival data file. Additionally, at step 401, an Infostructure related specifically to the metadata provided within the access or read request may be obtained and/or created based upon the type of data provided in the access request. At step 401, a device 10 (e.g., server system 206 or user system 220) may read the Infostructure of both the read request and the Archive Object to determine if an Archive Index and/or Infostructure is present, to then determine at step 402 whether such an index or Infostructure exists. If an Infostructure indeed exists within the read request provided, at step 403a, the existing Infostructure is simply returned to the requesting device, communicated within machines and/or systems of the device, or transmitted to another device for later processing at step 404. Alternatively, if no Infostructure is provided within the read request, at step 403b, a usable Infostructure may be selected and/or determined based upon the Archive Object and its corresponding Infostructure, which can be similarly handled at step 404. Once the read request validation phase 400 has been completed, further processing of the request may further improve the functionality of the archived system, according to the systems and methods of the disclosure contained herein.

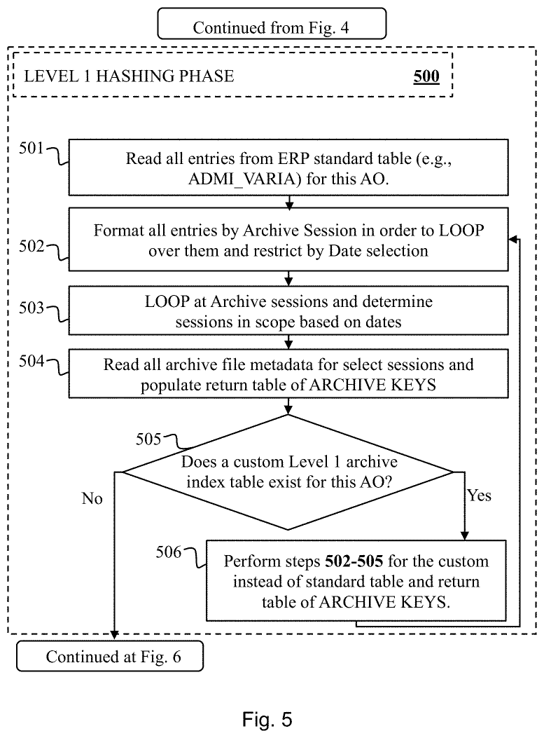

Referring now specifically to FIG. 5, therein illustrated is a detailed flowchart diagram of an exemplary hashing phase 500 of the present disclosure, as it may be implemented across various devices 10 within system 201. Hashing herein may occur at various Levels of complexity or may focus upon a first level or Level 1 hashing. At step 501 of hashing phase 500, all entries from the standard ERP system table are read for the Archive Object(s) specific to the read request(s). In a potentially preferred embodiment of an archival system designed specifically for SAP implementations, the ADMI VARIA may be the standard table which is read at step 501. Then, at step 502, all entries may be formatted by Archive Session so they may be looped and restricted by “Date” selection. Having formatted all entries by Archive Session so they may be looped and restricted by “Date” selection, the disclosed hashing phase 500 may then LOOP at Archive Sessions and determine which sessions are in scope of the read request(s) by corresponding date at step 503. At step 504 of hashing phase 500, those sessions determined to be in scope at step 503 may have all corresponding archive metadata read to populate a table of Archive Keys. Having obtained the table of Archive Keys, a system of the disclosure may then at step 505 determine if a new, custom, and/or additional Level 1 archive index may exist or be created, based upon the Archive Keys obtained at step 504. If such Level 1 archive may exist or be created, steps 502-505 may be repeated at step 506, but using the new, custom, and/or additional Level 1 archive index and/or infostructure system. Once the hashing phase 500 has been completed, further processing of the request at later phases may further improve the functionality of the archived system, according to the systems and methods of the disclosure contained herein. As the disclosed system and method relates to specific ERP systems, namely SAP, in combination with read request validation phase 400, hashing phase 500 may be understood to use the system tracking information in an ERP system table (e.g., ADMI VARIA of SAP) as a method of always knowing which ERP system Archive Files contain which data. Once the ERP system Archive File name alone has been obtained, the system can ensure, by the Archive File name alone, that the system of the disclosure is accessing the ERP system infostructure via Key Values because the system of the disclosure may utilize infostructures which always indicate the filename is a Key Value and not a data item, which would otherwise require further processing and/or reading beyond metadata. This ensures fast access when otherwise non-Key Values are user selected and a full-table scan may be triggered.

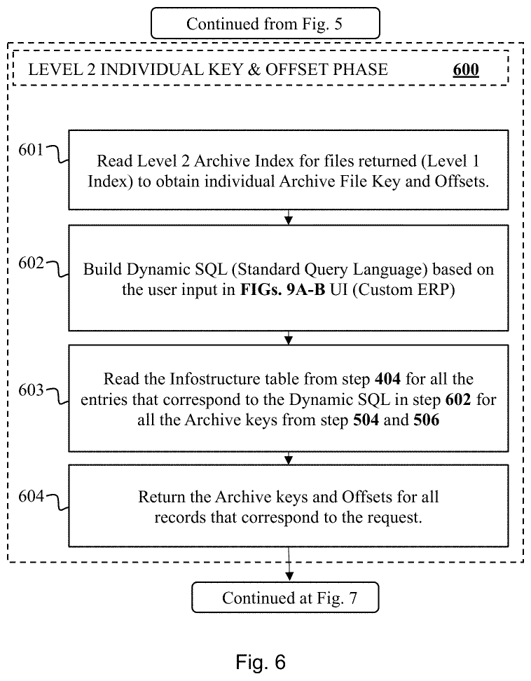

Referring now specifically to FIG. 6, therein illustrated is a detailed flowchart diagram of an exemplary Level 2 individual key and offset phase 600 of the present disclosure, as it may be implemented across various devices 10 within system 201. First, at step 601, the resulting Level 2 Archive Index for files returned from the Level 1 Archive Index may be read in order to later obtain the individual Archive File Key and Offsets. Then at step 602, a dynamic Standard Query Language (SQL) may be built or generated based upon a user input of query information into an Enterprise Resource Planning (ERP) system or software. See, e.g., FIGS. 9A-9B. In a potentially preferred embodiment of an archival system designed specifically for SAP implementations of the disclosed system and method, a customized version of SAP having additional add-on modules or features may be implemented to accomplish this step. Then at step 603, the resulting table from step 404 (e.g., a ZARIX table) may be read for all entries that correspond to the Dynamic SQL generated at step 602 and the Archive Keys generated at step 504 and/or step 506. Finally, step 604 of exemplary Level 2 individual key and offset phase 600 may instruct machines within system 201 to return Archive Keys and Offsets for all records that correspond to the user-initiated request, and the method of the disclosure can then proceed to offer instructions for its access method phase 700.

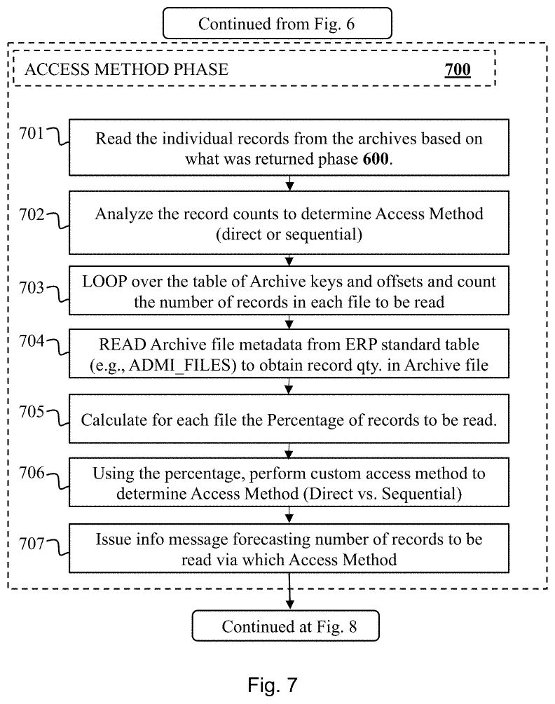

Referring now specifically to FIG. 7, therein illustrated is a detailed flowchart diagram of an exemplary access method phase 700 of the present disclosure, as it may be implemented across various devices 10 within system 201. As may be understood by those with ordinary skill in the art of customized ERP system deployment, typical ERP system access may require an archival access system to read Archive Files either sequentially or directly within a single request. These systems (e.g., SAP) do not, by default, usually include the capability to switch between both within a request. By facilitating both sequential and direct access based on the number of objects in an ADK file that are being read and determining which method will be faster in advance of performing an access and/or retrieval request, exemplary access method phase 700 may significantly decrease processing times. First, step 701 begins with reading the individual records from the archival database based upon what was returned at the completion of Level 2 individual key and offset phase 600, or step 604 which returned the archive keys and offsets for all records that correspond to the request. Next, record counts are analyzed to determine access method (e.g., direct or sequential) during step 702. At step 703, the table of archive keys and offsets are looped over and counted for the number of records in each file to be read. At step 704, Archive File metadata from the standard table of the ERP system (e.g., SAS) may be read to obtain the number of records in the Archive File. At step 705, a percentage may be calculated of the total records contained in the Archive File compared to the number of files that were determined relevant at step 703. Using this percentage, a determination may be made as to whether direct or sequential access for specific Archive Files may provide sooner results at step 706. Finally, an informational message may be issued at step 707, which contains a forecast of the number of records to be read and via which access method, in order to complete the access and/or retrieval request during results phase 800, detailed below.

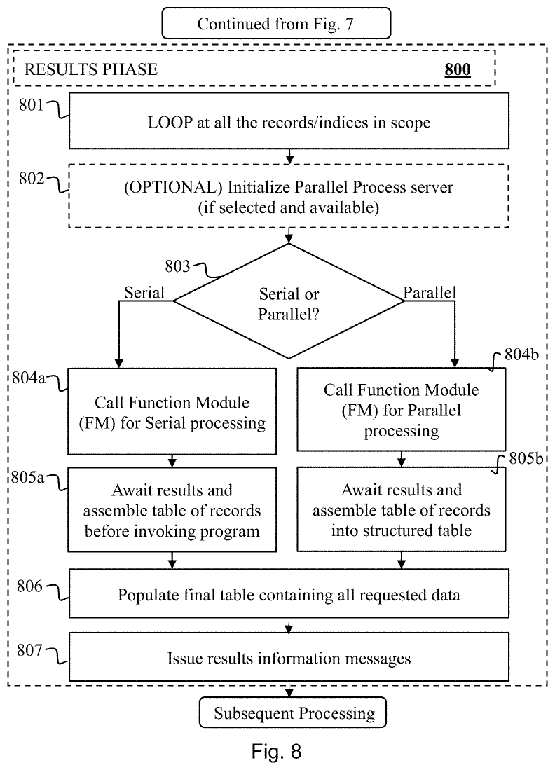

Referring now specifically to FIG. 8, therein illustrated is a detailed flowchart diagram of an exemplary results phase 800 of the present disclosure, as it may be implemented across various devices 10 within system 201. Results phase 800 offers several improvements to the end user of ERP systems. First, some ERP systems may issue errors or fail to complete access and/or retrieval jobs if dynamic access is utilized as too many records may be present to read at once (e.g., SAP ADK file access may issue a runtime error for insufficient space during dynamic access). Many times, switching to sequential access for the Archive File in question will circumvent this error. Additionally, once the system of the disclosure determines that multiple files need to be read in order to access and/or retrieve all the target data, then proceeding to read these files usually occurs more rapidly when the individual Archive Files are read asynchronously (in parallel) via a Function Module (FM) having remote call function capabilities. FM may generate remote calls using Dialog processes and return the corresponding result set back into the calling procedure once the asynchronous processes complete. This can reduce the elapsed time of the request by up to 90%. Beginning at step 801, the process begins by looping at all records and/or indexes in scope, based upon processing at previous steps in the phased archive access and retrieval method 300 of the present disclosure. Then, at optional step 802, a user may have selected and a parallel process server may be available, and if so, the system can then determine whether to proceed through Archive Files serially or in parallel at step 803. If serial is preferred, suggested, the only option available (due to lack of an available and/or connected parallel process server), and/or otherwise selected, at step 804a, results phase 800 may then proceed to call Function Module for serial processing, then at step 804b, proceed to await results and assemble a table of records before again invoking the program. If parallel processing is preferred at step 803, results phase 800 may instead call Function Module for parallel processing at step 804b. In this case, the receipt of results is then received and assembled into a table of records in a structured table format at step 805b. Then, after the completion of parallel processing and/or serial processing, the final table may be populated having all requested data at step 806, which can then be shared with device 10 in the form of an information message communicating the results are ready for access and/or retrieval. Having the data necessary for some enterprise-related task (e.g., creating reports), results phase 800 and phased archive access and retrieval method 300 may be completed and the enterprise related task can be completed with said necessary data.

Referring now specifically to FIG. 9A, therein illustrated is a screenshot drawing of an exemplary user interface 900 for accessing archival data, as it may be implemented across various devices 10 within system 201, and displayed on e.g., display 208. Dropdown selector 901 may be implemented as a jump-to navigator within an ERP system related to the disclosure. Other features of software known to those skilled in the art of the development of ERP systems and custom variations thereof would understand many alternative methods of allowing a user to navigate an ERP system. These may appear alongside dropdown selector 901, as illustrated therein FIG. 9A. Title window panel 910 may feature prominently the Archive Object being investigated. Archive Objects may be understood and/or grouped by business unit/entity. By way of example and not limitation, FI DOCUMNT may be a single Archive Object containing archived files or documents related to Financial Accounting (FI), SD_VBAK may contain sales orders, and MM_EKKO may contain purchase orders. The selection shown “ARC_FILE” in title window panel 910 has no known specific meaning and serves as a mere placeholder for the drawing. Next, sub-groups of Archive Files within the Archive Object may be selected for access and retrieval in sub-group selection panel 920. While three available selections may be visible in sub-group selection panel 920, the disclosure is not so limited. Then, keys for viewing Archive Files may be selected at key panel 930. These may include, by way of example and not limitation, those keys for viewing Archive Files illustrated therein key panel 930: Company code, Document Number, Fiscal Year, and Period. As illustrated thereon key panel 930, each key for viewing may provide a user a “min” or “low” and “max” or “high” value selection field which may be completed or left empty. Turning to general selections panel 940, therein illustrated are further exemplary selections a user may make upon both dropdown fields and value fields having min/max arrangement. Along both key panel 930 and selections panel 940 may be a column of UI buttons corresponding to each row which may cause fields to auto populate, information about a selection to be displayed, other user functionality and/or commands, and/or combinations thereof. In output options panel 950, a user may make decisions which may cause the ERP system to return data in a specified format or file. These exemplary choices illustrated thereon output options panel 950 are Display ALV of Single Tables, Display ALV of Joined Tables, Output to file, and Extract database tables also, but these may be added to, modified, deleted, or otherwise customized for a specific enterprise or user need. Finally, custom archive connector control options panel 960 may be present to allow users to e.g., Show Control Values. Additional custom options may be available to a user as will be apparent from a review of FIG. 9B and the relevant description below.

Referring now specifically to FIG. 9B, therein illustrated is a screenshot drawing of an exemplary user interface 900 for accessing archival data, as it may be implemented across various devices 10 within system 201, and displayed on e.g., display 208. FIG. 9B may be understood to share continuity with FIG. 9A in that the UI of the disclosure may allow a user to scroll within exemplary user interface 900 from FIG. 9A to FIG. 9B, or FIG. 9B may appear as a second screen after FIG. 9A has been completed, or after a selection is made (e.g., by checking “Show Control Values”). Dropdown selector 901 may be implemented as a jump-to navigator within an ERP system related to the disclosure. Other features of software known to those skilled in the art of the development of ERP systems and custom variations thereof would understand many alternative methods of allowing a user to navigate an ERP system. These may appear alongside dropdown selector 901, as illustrated therein FIG. 9B. Beginning at output options panel 950, a user may make decisions which may cause the ERP system to return data in a specified format or file. These exemplary choices illustrated thereon output options panel 950 in FIG. 9B may only include “Extract database tables also”, or may also include those listed in output options panel 950 as illustrated in FIG. 9A (i.e., Display ALV of Single Tables, Display ALV of Joined Tables, Output to file, and Extract database tables also). As stated previously, these options within output options panel 950 may be added to, modified, deleted, or otherwise customized for a specific enterprise or user need. Custom archive connector control options panel 960 may be present to allow users make further adjustments in advance of an access and/or retrieval request. These may include whether or not to show control values, or whether to select and/or identify Archive Files within Archive Objects having certain characteristics. First, hashing scheme and indexing options panel 970 may include user selections for hash source options, hash date (or year), hash month (if year), index source options, and infostructure. Then, a user may further customize its access and retrieval request by selecting options within access dynamic switching options panel 980. There, a user may assign an override switch point percentage and/or assign an override access method (e.g., direct vs. sequential). Finally, a user may then make further customizations to an intended access or retrieval request at archive connector control options panel 990. These may include whether to proceed in “Quiet Mode”, setting a maximum number of parallel processes, assign a server for processes, select read archive classes, assign Archive File keys, determine whether or not to join tables resulting from the request, and whether to include complete Archive Files only.

Having incorporated the disclosed system and method for the automated scheduling of archived data into several machines having ERP systems installed thereon, namely SAP, in order to automatically schedule archival creation of data within the ERP system, benefits were most clearly recognized by the lack of any necessary manual intervention during the generation of an archive and during later retrieval and access requests to the archival database using the disclosed system and method for the retrieval (and access) of archival data. Subsequent to the generation of an archival database according to the systems and methods disclosed herein, requests to the database with and without the use of the retrieval and access portions of the disclosed systems and methods were quantitatively compared, and a summary of the results are provided herein. While low-volume access and retrieval requests may have offered little-to-no perceivable reduction in completion time using the disclosed system and method, high-volume requests benefited greatly from the disclosed system and method—achieving anywhere from 10%-90% reductions time to completion, depending on the volume of the retrieval request. Additionally, requests for access and retrieval that would have ordinarily timed out and fail to return a user request prior to implementing the disclosed system and method were able to be completed and returned to the users making the requests.

With respect to the above description then, it is to be realized that the optimum methods, systems and their relationships, to include variations in systems, machines, size, materials, shape, form, position, function and manner of operation, assembly, order of operation, type of computing devices (mobile, server, desktop, etc.), type of network (LAN, WAN, internet, etc.), size and type of database, and use, are intended to be encompassed by the present disclosure.

It is contemplated herein that the system and method may be used to retrieve and schedule archiving, as well as automating a variety of other tasks and may be used in a manner to retrieve and schedule a variety of data types, including but not limited to customer data, user data, employee data, sales data, lead data, logistic event data, order data, inventory information and data, the like and combinations thereof. It is further contemplated that a variety of computing devices may be deployed on the system and method by a variety of service providers, managers, users, owners, agents, companies and other enterprises. These may include but are not limited to personal computers, laptops, desktops, mobile devices, smart phones, tablets, servers, virtualized machines, the like and/or combinations thereof. It is further contemplated that specialized equipment may be deployed to further improve the disclosed system and method. This description includes all manners and forms of systems and method for the retrieval and scheduling of archives, in all manner of devices and software platforms capable of such retrieval and scheduling of archives in order to automate, streamline, decrease runtime, increase efficiency of, and/or make possible the retrieval and scheduling of archives. While the implementation of the disclosed system and method may be most applicable and/or relevant to SAP and other ERP data archives, other platforms may benefit from the disclosed system and method, including but not limited to IBM Maximo, Infor ERP, IFS Applications, Xero, PeopleSoft, Workday Financial Management, Epicor, Sage Intacct, Oracle NetSuite, Microsoft alternatives, the like and/or combinations thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A data archival database management system for automatically archiving an active database stored on an at least one first computing device to an at least one second computing device, the system comprising:
the at least one first computing device having a first connection to a network, a first processor, a first memory, and a first non-transitory computer readable medium having said active database stored thereon;
the at least one second computing device having a second connection to said network, a second processor, a second memory, and a second non-transitory computer readable medium capable of storing a data archival store; and
an enterprise resource planning (ERP) system having an at least one variant list installed thereon said first non-transitory computer readable medium, said ERP system is configured to:
receive a user entry via said network from a user device connected to said network, said user entry contains a date range corresponding to a proposed data archive;
determine a period of time within said date range to divide said date range into a series of periods of time, each of said series of periods of time are associated with a mutually-exclusive data subset;
create a series of variants, each looped at each of said series of periods of time;
ensure mutual-exclusivity of each of said series of variants;
add said series of variants to said at least one variant list; and
processing a series of archival jobs, each of said series of archival jobs is associated with one of said series of variants.

2. The system of claim 1, wherein the ERP system is further configured to:
receive from said user device an archival data read request corresponding to an at least one Archive Object;
read whether said archival data read request possesses an Infostructure, and assign an existing Infostructure if none is present;
access a standard table of said ERP system, said standard table having a series of standard entries, and read all of said series of standard entries from said standard table; and
format said series of standard entries by an Archive Session order to enable looping and restriction to said date range.

3. The system of claim 2, wherein the ERP system is further configured to:
determine whether a custom index table having a series of custom entries exists for said at least one Archive Object; and
read said series of custom entries from said custom index table and format all of said series of custom entries by an at least one Archive Session.

4. The system of claim 3, wherein the ERP system is further configured to populate an at least one return table of Archive Keys corresponding to an at least one of said series of standard entries and said series of custom entries.

5. The system of claim 4, wherein the ERP system is further configured to:
read said at least one return table of Archive Keys to obtain an individual Archive File Key and a corresponding set of Offsets related to said date range;
build a dynamic SQL based on said date range;
read said Infostructure for all entries that correspond to said dynamic SQL; and
return said individual Archive File Key and said corresponding set of Offsets that correspond to said dynamic SQL.

6. The system of claim 5, wherein the ERP system is further configured to:
determine whether a direct access or a sequential access would generate a result faster for each of said individual Archive File Key and said corresponding set of Offsets;
calculate a percentage for each of said direct access and said sequential access; and
issue a message, the message containing a forecast of records to be read and whether each record will be read directly or sequentially.

7. The system of claim 6, further comprising a parallel process server and the ERP system has installed thereon a Function Module, the ERP system is further configured to:
initialize the parallel process server;
call said Function Module for parallel processing of said archival data read request;
await a results message containing a table of records; and
assembling said table of records into a structured table.

8. The system of claim 7, wherein the ERP system is further configured to populate a final table of records containing all data requested in the archival data read request and issue said final table of records as a message to the user device.

9. The system of claim 6, further comprising a parallel process server and the ERP system has installed thereon a Function Module, the ERP system is further configured to:
determine whether to process said archival data read request using serial or parallel processing;
if parallel, initialize the parallel process server and call said Function Module for parallel processing of said archival data read request;
if serial, call said Function Module for serial processing of said archival data read request;
await a results message containing a table of records;
assembling said table of records into a structured table; and
populate a final table of records containing all data requested in the archival data read request and issue said final table of records as a message to the user device.

10. A data archival database management method to automatically archive an active database stored on an at least one first computing device to an at least one second computing device, each of said at least one first computing device and said at least one second computing device having a processor, a memory, a non-transitory computer readable medium, a connection to a network, and access to an Enterprise Resource Planning system having an at least one variant list, the method comprising the steps of:
receiving, from a user device connected to said network, a date range corresponding to a proposed data archive via said network;
determining a period of time within said date range to divide said date range into a series of periods of time, each of said series of periods of time are associated with a mutually-exclusive data subset;
creating a series of variants, each looped at each of said series of periods of time;
ensuring mutual-exclusivity of each of said series of variants;
adding said series of variants to said at least one variant list; and
processing a series of archival jobs, each of said series of archival jobs is associated with one of said series of variants.

11. The method of claim 10, further comprising the steps of:
receiving from said user device an archival data read request corresponding to an at least one Archive Object;
reading whether said archival data read request possesses an Infostructure, and assign an existing Infostructure if none is present;
accessing a standard table of said ERP system, said standard table having a series of standard entries, and read all of said series of standard entries from said standard table; and
formatting said series of standard entries by an Archive Session order to enable looping and restriction to said date range.

12. The method of claim 11, further comprising the steps of:
determining whether a custom index table having a series of custom entries exists for said at least one Archive Object; and
reading said series of custom entries from said custom index table and format all of said series of custom entries by an at least one Archive Session.

13. The method of claim 12, further comprising the step of populating an at least one return table of Archive Keys corresponding to an at least one of said series of standard entries and said series of custom entries.

14. The method of claim 13, further comprising the steps of:
reading said at least one return table of Archive Keys to obtain an individual Archive File Key and a corresponding set of Offsets related to said date range;
building a dynamic SQL based on said date range;
reading said Infostructure for all entries that correspond to said dynamic SQL; and
returning said individual Archive File Key and said corresponding set of Offsets that correspond to said dynamic SQL.

15. The method of claim 14, further comprising the steps of:
determining whether a direct access or a sequential access would generate a result faster for each of said individual Archive File Key and said corresponding set of Offsets;
calculating a percentage for each of said direct access and said sequential access; and
issuing a message, the message containing a forecast of records to be read and whether each record will be read directly or sequentially.

16. The method of claim 15, further comprising the steps of:
initializing a parallel process server connected to said network;
calling a Function Module of said ERP system for parallel processing of said archival data read request;
awaiting a results message containing a table of records; and
assembling said table of records into a structured table.

17. The method of claim 16, further comprising the steps of populating a final table of records containing all data requested in the archival data read request and issuing said final table of records as a message to the user device.

18. The method of claim 15, further comprising the steps of:
determining whether to process said archival data read request using serial or parallel processing;
if parallel, initializing the parallel process server and calling a Function Module of said ERP system for parallel processing of said archival data read request;
if serial, calling said Function Module for serial processing of said archival data read request;
awaiting a results message containing a table of records;
assembling said table of records into a structured table; and
populating a final table of records containing all data requested in the archival data read request and issuing said final table of records as a message to the user device.

19. A system for an automatic archival of an active database, the system comprising:
a plurality of computing devices, said plurality of computing devices having a processor, a memory, a non-transitory computer-readable medium, and a connection to a network;
installed thereon an at least one of said plurality computing devices is an Enterprise Resource Planning (ERP) system having a data archival feature, the remaining of said plurality of computing devices having access to said ERP system via said network; and
the ERP system and the data archival feature are capable of scheduling the automatic archival of said active database according to the following steps:
receiving, from a user device connected to said network, a date range corresponding to a proposed data archive via said network;
determining a period of time within said date range to divide said date range into a series of periods of time, each of said series of periods of time are associated with a mutually-exclusive data subset;
creating a series of variants, each looped at each of said series of periods of time;
ensuring mutual-exclusivity of each of said series of variants;
adding said series of variants to said at least one variant list; and
processing a series of archival jobs, each of said series of archival jobs is associated with one of said series of variants.

20. A system for an efficient user access to an archive generated by the system of claim 19, the system enabling a user to complete the following steps in order to access the archive:
receiving from said user device an archival data read request corresponding to an at least one Archive Object;
reading whether said archival data read request possesses an Infostructure, and assign an existing Infostructure if none is present;
accessing a standard table of said ERP system, said standard table having a series of standard entries, and read all of said series of standard entries from said standard table;
formatting said series of standard entries by an Archive Session order to enable looping and restriction to said date range;
determining whether a custom index table having a series of custom entries exists for said at least one Archive Object;
reading said series of custom entries from said custom index table and format all of said series of custom entries by an at least one Archive Session;
populating an at least one return table of Archive Keys corresponding to an at least one of said series of standard entries and said series of custom entries;
reading said at least one return table of Archive Keys to obtain an individual Archive File Key and a corresponding set of Offsets related to said date range;
building a dynamic SQL based on said date range;
reading said Infostructure for all entries that correspond to said dynamic SQL;
returning said individual Archive File Key and said corresponding set of Offsets that correspond to said dynamic SQL;
determining whether a direct access or a sequential access would generate a result faster for each of said individual Archive File Key and said corresponding set of Offsets;
calculating a percentage for each of said direct access and said sequential access;
issuing a message, the message containing a forecast of records to be read and whether each record will be read directly or sequentially;
determining whether to process said archival data read request using serial or parallel processing and:
if parallel, initializing the parallel process server and calling a Function Module of said ERP system for parallel processing of said archival data read request; or
if serial, calling said Function Module for serial processing of said archival data read request;
assembling said table of records into a structured table; and
populating a final table of records containing all data requested in the archival data read request and issuing said final table of records as a message to the user device.
